(19) United States
(12) Patent Application Publication
(10) Pub. No.: US 2009/0149185 A1
(43) Pub. Date: Jun. 11, 2009

(54) METHOD AND APPARATUS FOR REDUCING MISSED PAGING MESSAGES AND PAGING LATENCY DURING CELL RESELECTION IN A WIRELESS NETWORK

(75) Inventor: MURALI NARASIMHA, LAKE ZURICH, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/951,747

(22) Filed: Dec. 6, 2007

(51) Int. Cl. H04Q 7/36

(52) U.S. Cl. 455/442

(57) ABSTRACT

A mobile station anticipates that an asynchronous idle handover or cell reselection is about to occur and just prior to the occurrence will determine if the idle mode handover/cell reselection interval will cause missing of a paging interval and thus a missed paging opportunity using an estimated handover duration. If not, then the mobile station will proceed with the idle mode handover (713). However, if the mobile station determines that a paging opportunity will be missed, then it will send an “idle handover start” message to the serving BTS (714). The BTS may, depending upon the time at which the message was received, stop or delay the transmission of pages during the time interval in which the mobile station is performing the idle mode handover. The mobile station performs the idle mode handover (717), and will receive a re-page at a small time offset (719).

### FIELD OF THE DISCLOSURE

The present disclosure relates to wireless communication networks and to paging of mobile devices via such networks on a paging channel, paging interval, or paging opportunity, and methods and apparatuses for reducing or preventing a mobile station from missing paging due to mobile station operations such as cell reselection, also referred to as idle mode handover, which prevent the mobile station from receiving paging messages.

### BACKGROUND

Certain wireless networks such as, but not limited to, networks specified by the 3^{rd} Generation Partnership Project (3GPP), do not require that base transceiver stations (BTS), within the network be synchronized. Other wireless networks may synchronize the BTSs for example, CDMA networks synchronize the base stations using Global Positioning System (GPS) timing information where each CDMA BTS has a collocated GPS receiver. A BTS provides a radio coverage area and is sometimes referred to as a “cell.” The “cell” may also be sectored, typically into three sectors, by utilizing antennas having predetermined beam widths, such as but not limited to, 120 degree beam widths. GPS receivers may usually make use of the antenna towers of the BTS and be collocated with the antennas.

The GPS equipment is somewhat expensive and, because the GPS receiving equipment requires a hemispheric view, it is not always feasible to provide collocated GPS receivers at network BTS sites, particularly at in-building sites. The lack of synchronization between wireless network BTS places a burden on a mobile station as it moves between BTS radio coverage areas.

A mobile station must perform a “cell reselection” or “idle mode handover” when it moves out of the radio coverage area of one BTS sector or cell to another. The terminologies “cell reselection” and “idle mode handover” are used within the various 3GPP and 3GPP2 technical specifications respectively, and are used interchangeably herein. The idle mode handover or cell reselection is performed autonomously by the mobile station and the BTS is not aware of the mobile station moving into the new sector unless or until the mobile station transmits a location update after it completes the idle mode handover. An idle mode handover (or cell reselection) is distinguishable from a “in-call” handover in that the mobile station is not engaged in a call or any data transaction with the network, but rather is operating in an “idle mode.”

Because the BTS, and thus the network, is not aware of the handover, there is a likelihood that the mobile station will miss pages sent by the network while a mobile station idle mode handover is in progress. Various scenarios may occur that could result in missed pages. For example if the source cell and target cell belong to different paging zones, a page may be sent in the source paging zone after the mobile station handed over to the target cell paging zone and is thus unable to receive the page in the source cell paging zone.

Even if the source and target cells are in the same paging zone, a page may be sent at a time when the mobile station has stopped listening to the paging channel of the source cell, but has not yet acquired the signal of the target cell. Further, where cells are not synchronized, paging messages from the two cells will likely not be transmitted at the same time. If the time offset between the two paging message transmissions is small, the mobile station might miss the page from both the first cell and the second cell.

Thus what is needed are methods and apparatuses to prevent or reduce missed paging messages during the time interval that a mobile station performs an idle mode handover.

### BRIEF DESCRIPTION OF THE DRAWINGS

FIG. 1A and FIG. 1B are a network diagram key, and network diagram, respectively, illustrating how a mobile station may transition and handover between cells or sectors of different paging zones or of cells or sectors of the same paging zone during mobile station idle mode.

FIG. 2 is a signal timing diagram illustrating how a mobile station transitioning as illustrated in FIG. 1B, may miss a paging message in a synchronized network.

FIG. 3 is a signal timing diagram illustrating a first scenario where a mobile station transitioning as illustrated in FIG. 1B, may miss a paging message in an unsynchronized network.

FIG. 4 is a signal timing diagram illustrating a second scenario where a mobile station transitioning as illustrated in FIG. 1B, may miss a paging message in an unsynchronized network.

FIG. 5 is a signal timing diagram illustrating a first scenario in accordance with a first embodiment.

FIG. 6 is a signal timing diagram illustrating a second scenario in accordance with the first embodiment.

FIG. 7 is a signal timing diagram illustrating a first scenario in accordance with a second embodiment.

FIG. 8 is a signal timing diagram illustrating a second scenario in accordance with the second embodiment.

FIG. 9A and FIG. 9B are flow charts illustrating operation of the embodiments for various scenarios such as those described by FIG. 5, FIG. 6, FIG. 7 and FIG. 8.

FIG. 10 is a block diagram of a BTS in accordance with the embodiments,.

FIG. 11 is a block diagram of a mobile station in accordance with the embodiments.

### DETAILED DESCRIPTION

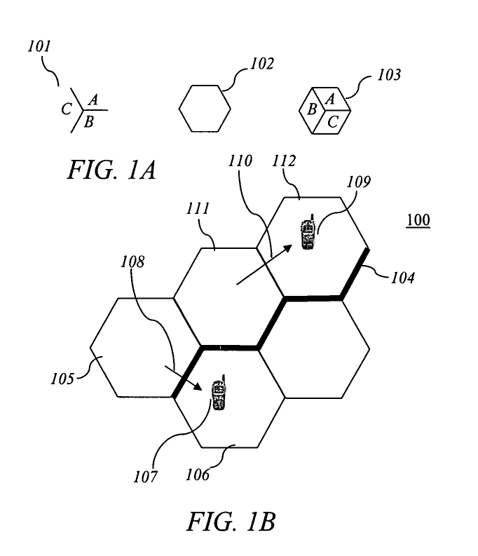

FIGS. 1A and 1B illustrate the case of a mobile station crossing cell or sector paging boundaries. FIG. 1A illustrates a symbol for a sectored cell 101 having three sectors A, B and C. Symbol 102 is a representation of a cell's entire radio coverage area such that a sectored cell may be represented by the symbol 102 as an ideal case radio coverage area. A cell radio coverage area has in reality a staggered boundary that will overlap the coverage area of other neighboring cells. For simplicity the symbol 102 is used and may represent a sectored cell as in 103. In reality, the sectors of the various cells will not always be in the same direction and it is to be understood that FIG. 1B therefore is for illustrative purposes only.

FIG. 1B illustrates two scenarios. For example, in a first scenario, mobile station 107 moves between cells 105 and 106. The cells are contained within a larger paging area where, in FIG. 1B, only the paging area boundary 104 is shown. As the mobile station moves between cell 105 and cell 106 in the direction 108 as shown, the mobile station also crosses the paging area boundary 104 because cell 106 is in a different paging area than is cell 105.

A second scenario is shown by the mobile station 109 which is shown moving in direction 110, from cell 111 to cell 112. In this scenario cell 111 and cell 112 are in the same paging area so the mobile station 109 is crossing between cell boundaries only.

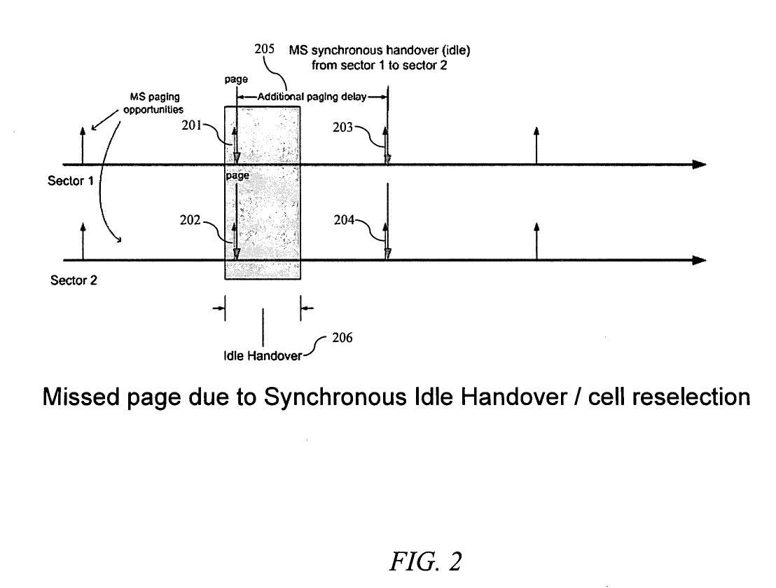

FIG. 2 is a timing diagram showing why a mobile station may miss a paging message for the scenarios illustrated by FIG. 1B. FIG. 2 illustrates the case of synchronized cells, where paging messages will be sent by all cells at the same point in time. The cell sectors send the paging messages at periodic intervals. As a mobile station crosses a cell boundary and performs an idle handover, some processing time during the idle handover interval 206 is required. Thus the mobile station serving cell may send a paging message 201 and the mobile station handover target cell may send the paging message 202, both during the idle handover time interval 206. The mobile station would therefore not be able to receive a page during the idle handover interval 206 and would have to wait until paging message 203 or paging message 204 thus incurring the paging delay 205.

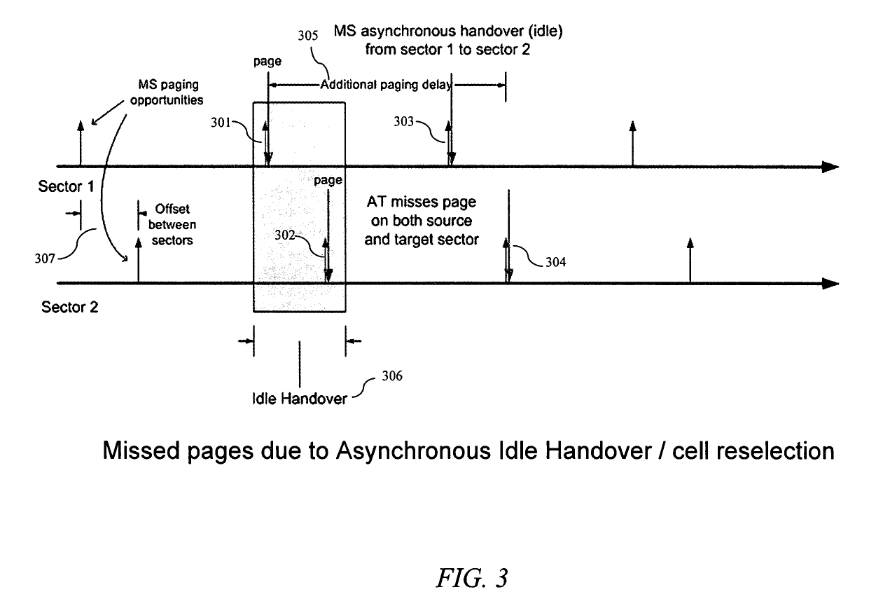

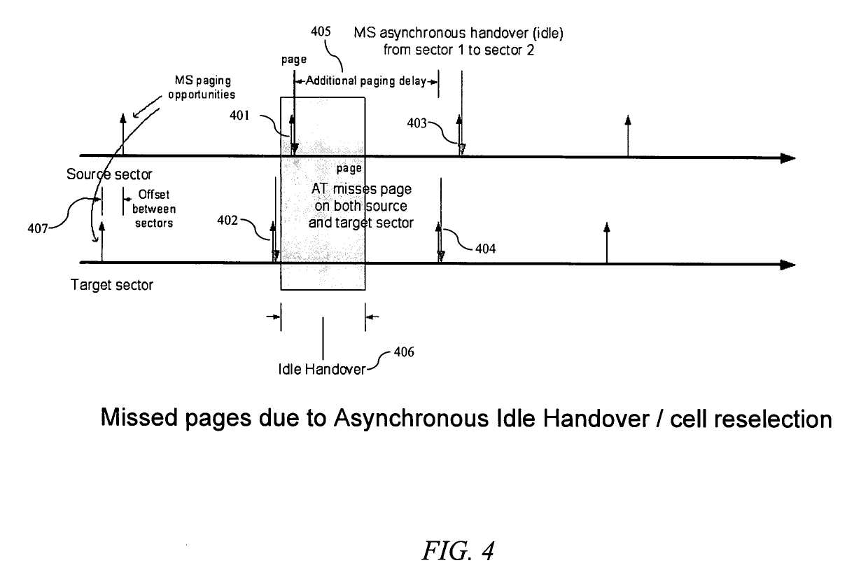

FIG. 3 and FIG. 4 illustrate scenarios where paging delay may be encountered when the cells are not synchronized. In the example illustrated by FIG. 3, the serving and target cell transmit their respective paging messages at an offset interval 307. As the mobile station begins its idle handover interval 306 the first cell transmits paging message 301 which is therefore missed by the mobile station. Because the idle handover interval 306 is longer than the offset interval 307, the second cell sends its paging message 302 within the idle handover 306 and is therefore also missed by the mobile station. Note also that the first and second cells are interchangeable as the serving and target cells because the of the asynchronous nature of the network. The mobile may therefore not receive a page for as long as the paging delay 305 in cases where cell 2 is the target cell and sends paging message 304.

In the example of FIG. 4, the first paging message 401 again occurs within the idle handover interval 406. However in this case, the target cell has transmitted its paging message 402 just prior to the mobile station beginning the idle mode handover or cell reselection. The terminology “idle mode handover” and “cell reselection” are used interchangeably herein as was discussed previously. Thus the mobile station was not able to receive paging message 402 or 401, since paging message 402 was sent prior to the mobile station being in the target cell coverage area, while paging message 401 was sent during the idle handover interval 406 because of the short offset 407 between the serving cell and target cell paging message intervals. The mobile station will therefore receive the target cell paging message 404 after incurring the paging delay interval 405.

As can be seen from the examples of FIG. 3 and FIG. 4, the problem would occur at even greater frequencies in dense urban environments with many cells that are not synchronized because a mobile station would likely encounter a greater number of idle mode handovers.

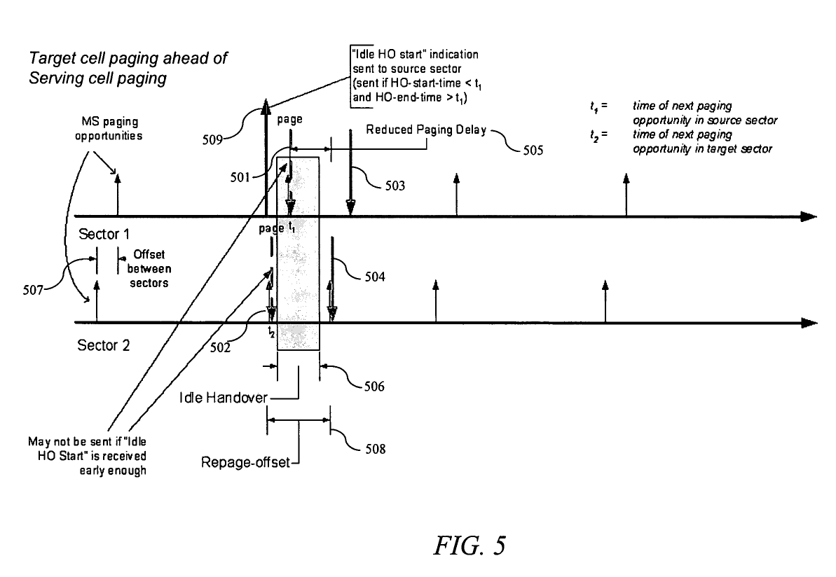

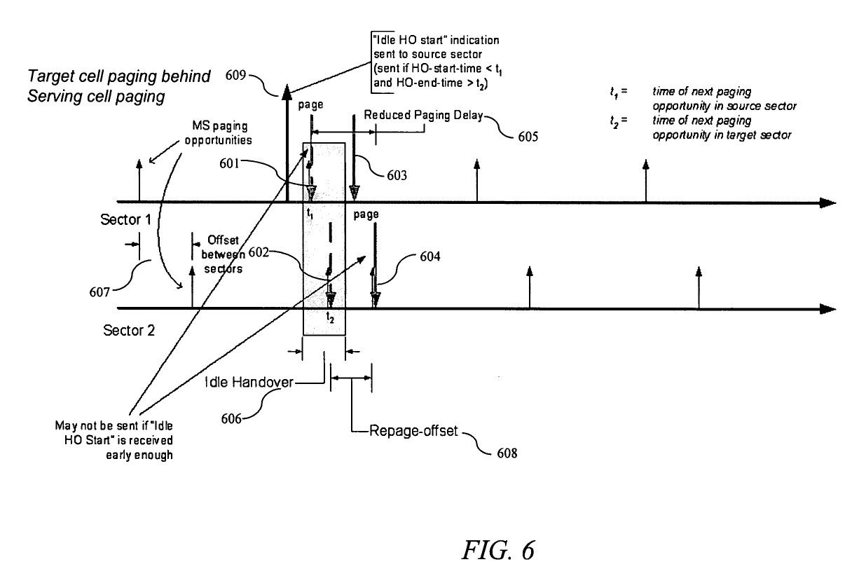

FIG. 5 and FIG. 6 illustrate methods in accordance with the embodiments. In accordance with the embodiments, a “fast re-paging” is used only for mobile stations that have just completed an idle handover. FIG. 5 illustrates a scenario wherein a target cell paging interval is ahead in time of the mobile station serving cell paging interval. Thus there is a paging offset interval 507 as illustrated. Prior to the start of the idle handover interval 506, the mobile station will send a message 509 to the network via the source or serving cell indicating that it is going to perform an idle handover. The mobile station may send this “Idle handover start” indication message 509 over an access channel.

In some embodiments, the idle handover start message 509 does not need to be acknowledged by the serving cell, such that the mobile station does not have to wait before it starts the idle handover. The page 501 from the serving cell and the page 502 from the target cell would be missed by the mobile station as was described previously with respect to the example illustrated by FIG. 4. In the embodiments, the idle handover start message 509 may be received by the network early enough such that page 501 and page 502 may not be transmitted because in that case, the network would be aware of the mobile station's handover interval prior to transmitting the pages.

However if the pages are transmitted, and there is no response to the first page 502, the network will use a fast re-paging 504 mechanism with a short re-page offset 508, only if it has received the “idle handover start” message 509 subsequent to the previous paging opportunity. Otherwise the network will assume that the lack of response to the page is not due to an idle handover and will therefore transmit the page at the regular re-paging interval. The paging delay 505 will thereby be reduced as shown in FIG. 5.

FIG. 6 illustrates a scenario of the embodiments where the target cell paging interval is behind in time from the serving cell paging interval and thus has the paging interval offset 607. The mobile station sends the idle handover start message 609, which if received early enough, may prevent transmission of page 601 and page 602. However, if page 601 and 602 are not responded to by the mobile station, and an idle handover start message 609 was received by the network, the re-page 604 will be transmitted by the target cell during the re-page offset interval 608.

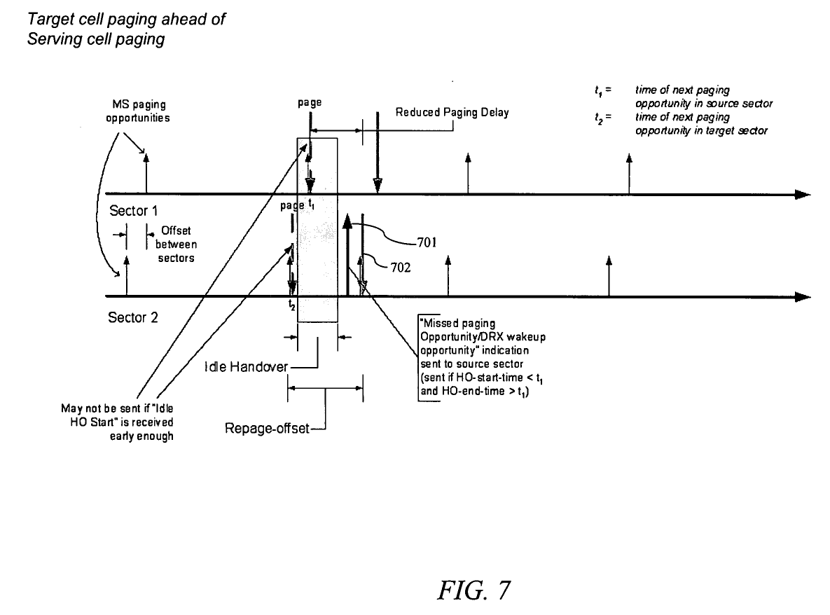

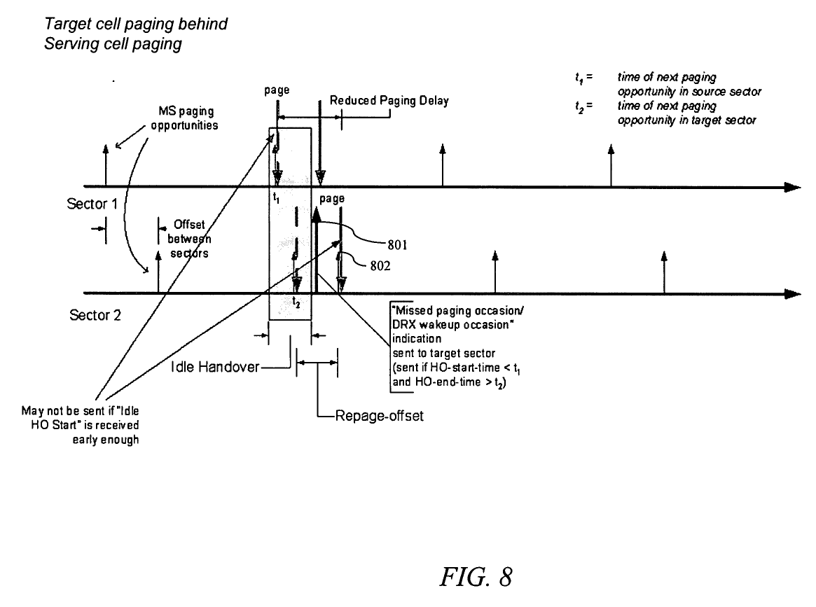

FIG. 7 and FIG. 8 illustrate the same scenarios illustrated in FIG. 5 and FIG. 6, but for a second embodiment. FIG. 7 and FIG. 8 are applicable to networks in which a mobile station may have a discontinuous receive (DRX) mode of operation. The mobile station further has a DRX wake-up interval which may be, for example, 20 ms in duration. In embodiments having mobile stations with DRX the network only pages during the mobile station DRX wake-up interval. Further, a mobile station in a DRX state may not be merely in an idle mode, but may also be in a connected state however without an assigned traffic channel. This state is referred to as an RRC (Radio Resource Control) connected state.

Returning to FIG. 7, the scenario is the same as that illustrated in FIG. 5 wherein the target cell paging interval is ahead in time of the serving cell paging interval. In this scenario, the mobile station sends a “missed paging opportunity/DRX wakeup opportunity” message 701 to the target cell. The target cell then sends re-page 702 in response and at a short offset corresponding to the mobile station DRX wake-up. Similarly in FIG. 8, which shows the same scenario as FIG. 6, the mobile station sends the “missed paging opportunity/DRX wakeup opportunity” message 801 to the target cell and the target cell then sends re-page 802 in response and at a short offset corresponding to the mobile station DRX wake-up.

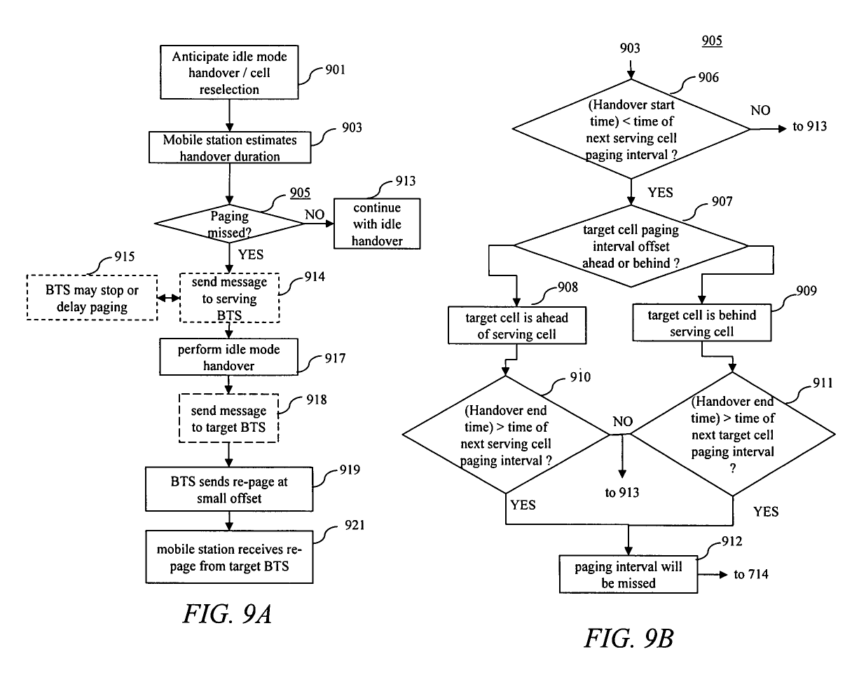

FIG. 9A and FIG. 9B summarizes the logical operation of the embodiments illustrated by FIG. 5, FIG. 6, FIG. 7 and FIG. 8. In accordance with the embodiments, just prior to an asynchronous idle mode handover, the mobile station will determines if the idle handover interval will cause miss of a paging interval and thus a missed paging opportunity using an estimated handover duration. The handover duration estimate may be made using data stored in the mobile station memory and may further be based upon empirical network data. The data may be based upon various factors such as time of day/busy hour, and whether the target cell is in an identical control area, switching area, location area, etc., as defined by the network plan, or any other factor that may weight or effect the duration of the idle mode handover interval.

The mobile station in 901 anticipates that an idle handover is about to occur. This determination may be based upon various parameters measured by the mobile station, or by parameters or commands sent to the mobile station by the mobile station's serving cell. The serving cell is also referred to as the “source” cell or “source sector” interchangeably herein. The mobile station then, in 903 estimates the handover duration as discussed above. In 905 the mobile station determines whether a paging interval will be missed due to the idle handover interval duration. If not, then the mobile station will proceed with the idle mode handover as in 913.

However, if the mobile station determines that a paging interval, and therefore a paging opportunity, will be missed, then it will send an “idle handover start” message to the serving BTS as in 914. The BTS may, depending upon the time at which the message was received, stop or delay the transmission of pages during the time interval in which the mobile station is performing the idle mode handover.

The mobile station performs the idle mode handover in 917, and will receive a re-page at a small time offset in 919, and as was illustrated in FIG. 5 and FIG. 6. The mobile station in 921 receives the re-page. As discussed with respect to FIG. 7 and FIG. 8, the mobile station may in some embodiments instead send a “missed paging opportunity/DRX wakeup opportunity” to the target cell in 918, after it has performed the idle mode handover in 917. In this case the target BTS will still send a re-page in 919, but the timing will relate to the mobile station DRX wake-up, which is a special DRX wake-up for the purpose of receiving the re-page in 921.

FIG. 9B provides further details of the logic of block 905. The mobile determines in 906 whether the handover start time will be prior to the occurrence of the next paging interval, or paging opportunity, of the serving cell. If not, then the mobile station will continue with the idle mode handover as in 913.

However, if yes, then the mobile station in 907 will, determine whether the target cell paging interval is ahead of the serving cell in 908, or behind the serving cell in 909. The mobile station will then determine whether a page may be receivable after the end of the idle mode handover interval. Specifically, the mobile station will determine if the idle mode handover interval will be greater than the time to the next paging interval of either the serving cell in 910, or the target cell 911, depending upon which cell paging interval if first or second.

If a paging could be received, that is, if the target cell paging is ahead of the serving cell paging and the result of block 910 is no, (or if block 911 is no if the target cell paging is behind the serving cell paging), then the mobile station will continue with the idle mode handover as in 913. However, if the idle mode handover interval exceeds the time to the next paging interval, from the serving cell in 910, or from the target cell in 911, then the mobile station determines that the paging interval will be missed in 912, and proceeds to block 914.

The mobile station as discussed above with respect to FIG. 9A will perform the idle mode handover in 917, and wakes up at the “re-page offset” after the regularly scheduled paging slot to receive the re-page in 921. The BTS will only send the re-page in 919 if the network has received “idle mode handover start” message from the mobile station. The network may also delay paging until a “re-page offset” after the mobile station's regularly scheduled paging slot. Otherwise, only a regular page will be sent. In the second embodiment, the re-page will be sent only if the network received the “missed paging opportunity/DRX wakeup opportunity” message in 918.

Thus in the first embodiment herein described reduce the paging load over other re-paging schemes on a network by re-paging only for cases where the network has received an “idle mode handover start” message from the mobile station and therefore is aware of the mobile station's condition. In the second embodiment herein described, the same is achieved by informing the network of the missed paging interval after completion of the idle mode handover interval.

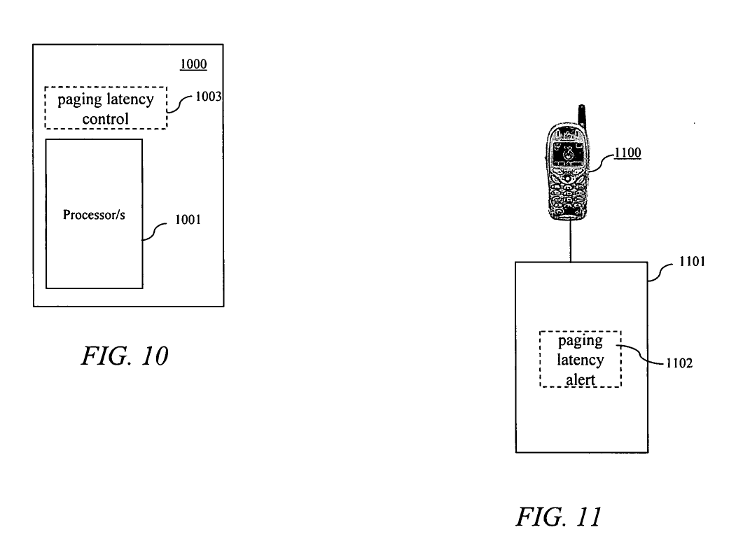

FIG. 10 illustrates a BTS 1000 of the embodiments which includes processors 1001 and a paging latency control module 1003 for receiving the “idle mode handover start” message from the mobile station and taking appropriate action with respect to paging as discussed above. FIG. 11 illustrates further detail of mobile station 1100 in accordance with the embodiments. Mobile station 1100 comprises components as known by those of ordinary skill such as, but not limited to, user interfaces, graphical display, transceiver/s, one or more radio stacks for sending and receiving messages to and from the network, and processor/s 1101. In addition, the mobile station 1100 comprises a paging latency alert module 1102 for performing the operations illustrated with respect to FIG. 9A and FIG. 9B and for sending the messages described above to an appropriate BTS in accordance with the embodiments as described in detail above.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station, said method comprising:
determining that a cell-reselection interval will overlap in time a paging interval, said cell reselection interval being a longer time interval than said paging interval; and
sending a message to a base station, said message providing information about said cell-reselection of said mobile station.

2. The method of claim 1, wherein sending a message to a base station, said message providing information about said cell reselection of said mobile station, further comprises:
sending a message to a base station indicating that said mobile station is beginning said cell reselection interval.

3. The method of claim 1, wherein sending a message to a base station, said message providing information about said cell reselection of said mobile station, further comprises:
sending a message to a base station indicating that said mobile station has completed said cell reselection interval.

4. The method of claim 1, wherein sending a message to a base station, said message providing information about said cell reselection of said mobile station, further comprises:
sending a message to a base station indicating that said mobile station has missed said paging interval.

5. The method of claim 1, further comprising:
waking up at a re-page offset interval, said re-page offset interval occurring after said paging interval; and
receiving a paging message.

6. The method of claim 1, wherein determining that an cell reselection interval will occur during a paging interval further comprises:
determining that said cell reselection interval will start before a serving cell paging interval; and
determining that said cell reselection interval will finish after a second paging interval.

7. The method of claim 6 wherein determining that said cell reselection interval will finish after a second paging interval further comprises:
determining that said cell reselection interval will finish after a second paging interval of said serving cell.

8. The method of claim 6 wherein determining that said cell reselection interval will finish after a second paging interval further comprises:
determining that said cell reselection interval will finish after a second paging interval from a target cell, said target cell being handed over to from said serving cell by said mobile station during said cell reselection interval.

9. A method of operating a network entity, the method comprising:
receiving a message from a mobile station, said message providing information about a mobile station cell reselection, said cell reselection having an cell reselection interval causing said mobile station to miss a paging interval; and
sending a re-page message to said mobile station after said cell reselection interval and before said paging interval.

10. The method of claim 9, wherein receiving a message from a mobile station, said message providing information about a mobile station cell reselection, said cell reselection having an cell reselection interval causing said mobile station to miss a paging interval, further comprises:
receiving a message from a mobile station indicating that said mobile station will begin performing an cell reselection.

11. The method of claim 9, wherein receiving a message from a mobile station, said message providing information about a mobile station cell reselection, said cell reselection having an cell reselection interval causing said mobile station to miss a paging interval, further comprises:
receiving a message from a mobile station indicating that said mobile station has completed performing an cell reselection.

12. The method of claim 9, wherein receiving a message from a mobile station, said message providing information about a mobile station cell reselection, said cell reselection having a cell reselection interval causing said mobile station to miss a paging interval, further comprises:
receiving a message from a mobile station indicating that said mobile station has missed said paging interval.

13. The method of claim 9, wherein sending a re-page message to said mobile station after said cell reselection interval and before said paging interval further comprises:
sending a re-page message to said mobile station from a serving cell of said mobile station.

14. The method of claim 9, wherein sending a re-page message to said mobile station after said cell reselection interval and before said paging interval further comprises:
sending a re-page message to said mobile station from a target cell of said mobile station, said target cell being handed over to from a serving cell by said mobile station during said cell reselection interval.
